(19) United States
(12) Patent Application Publication
(10) Pub. No.: US 2024/0190405 A1
(43) Pub. Date: Jun. 13, 2024

(54) 3/2-WAY VALVE CONCEPT FOR A HYDRAULIC ACTUATION SYSTEM

(71) Applicants: Heinz LEIBER, Oberriexingen (DE); IPGATE AG, Pfäffikon/Sz (CH)

(72) Inventors: Heinz LEIBER, Oberriexingen (DE); Anton VAN ZANTEN, Ditzingen (DE)

(21) Appl. No.: 18/285,972

(22) PCT Filed: Jan. 28, 2022
(86) PCT No.: PCT/EP2022/052023

§ 371 Date: Oct. 6, 2023

(30) Foreign Application Priority Data
Apr. 7, 2021 (DE) 20 2021 105 880.3

(51) Int. Cl. B60T 8/34; B60T 8/40

(52) U.S. Cl. CPC B60T 8/341; B60T 8/4081

(57) ABSTRACT

A hydraulic actuation system for a hydraulic braking system may include at least one hydraulic circuit having at least one hydraulically actuated wheel brake and at least one pressure generating device comprising a piston pump. The at least one pressure generating device is used for pressure control or regulation in the at least one hydraulic circuit. The pressure generating device may be selectively connected to/disconnected from a supply reservoir by means of at least one control 3/2-way valve.

The present invention relates to a hydraulic actuation system for a hydraulic system, in particular in the form of a brake system, having at least one hydraulic circuit which is provided with at least one hydraulic consumer, in particular in the form of a hydraulically actuated wheel brake, and having at least one pressure generating device with a piston pump or a rotary pump for pressure control or regulation, in particular for pressure build-up and pressure reduction in the at least one hydraulic circuit.

Such hydraulic actuation systems are sufficiently well known. In automotive engineering, 3/2 valves find versatile application, as disclosed in DE 10 2017000472, where a 3/2-way valve is used for selective connection of a brake circuit to the pressure supply or to a tandem master brake cylinder. The use of a 3/2-way valve can advantageously save a valve when only 2/2-way valves have been used previously.

In many valve applications, the safety requirements for a valve failure are high, as they can have an impact on the braking effect and pedal characteristics.

### TASK OF THE INVENTION

It is the task of the present invention to design a generic hydraulic actuation system, in particular for a braking system, in a more fail-safe and cost-effective manner.

This task is solved according to the invention with a hydraulic actuating system having the features of claim 1. Further advantageous embodiments of the actuation system according to claim 1 result from the features of the subclaims.

With the actuation system according to the invention, the pressure can advantageously be regulated or controlled very precisely.

The pressure generating device can advantageously comprise a piston pump. In automotive engineering, there is a wide range of applications for the actuation systems according to the invention. Compared to rotary pumps, electric motor-driven piston-cylinder systems with plunger or double-stroke pistons offer great advantages in continuous medium delivery or also in controlled volume delivery by means of piston displacement measurement or pressure measurement, in which, for example, a very specific volume of hydraulic medium is adjusted by controlled or regulated adjustment of the piston, whereby, for example, a preset pressure can be set or regulated on the basis of a pressure-volume characteristic curve.

However, it is particularly advantageous if the pressure-generating device has a double-stroke piston, so that hydraulic medium can be conveyed in the forward stroke and in the return stroke, and that each working chamber of the pressure-generating device can be connected to the reservoir via a 3/2-way valve, in particular one assigned to it. With this valve circuit described above, for example, any of the currently required functions of a braking system can be realized or set with the piston. For example, it is also possible to adjust the double-stroke piston of the pressure generating device without delivering hydraulic medium, which is generally referred to as an idle stroke without volume delivery into or out of the hydraulic circuits or brake circuits.

However, it is also possible to use a double-stroke piston pump with a 3/2-way valve assigned to only one working chamber or brake circuit and only a 2/2-way valve assigned to the other. In this arrangement, it is then only possible to connect one brake circuit to the reservoir in order to drain hydraulic medium into it or to receive hydraulic medium from it.

In another possible embodiment, the two working chambers of the pressure-generating device can be connected to the reservoir via a single 3/2-way valve, in which case at least one working chamber is always hydraulically connected to the reservoir. As long as the 3/2-way valve can be held in an intermediate position by means of the electromagnetic drive, it is also possible for both working chambers of the piston-cylinder unit of the pressure-generating device to be hydraulically connected to the reservoir at the same time.

If the hydraulic actuation system with double-stroke pistons according to the invention is used for pressure control of a brake system, it can deliver the hydraulic medium to both brake circuits in the forward stroke as well as in the return stroke. In the event of a failure of one brake circuit (circuit failure), the advantageous valve circuit can continue to control the pressure in the other still intact brake circuit by means of the actuation system.

The brake system can advantageously have a master brake cylinder that is designed either as a tandem or single master brake cylinder. The master cylinder thus has at least one working chamber which can be connected via a 3/2-way valve either in the return plane to a brake circuit or, in the normal case, to a travel simulator for setting a pedal feel. If the master brake cylinder is designed as a tandem master brake cylinder with two working chambers, one of its working chambers can be connected to the brake circuit and travel simulator via a 3/2 directional control valve as described above and the other working chamber can be disconnected from the other brake circuit or connected to it in the return plane by means of a 2/2 directional control valve.

As already described, the pressure supply with so-called dual-circuit double-stroke piston (DHK) enables continuous volume conveyance. With the valve circuit according to the invention, the alternating single-circuit double-stroke piston can distribute the volume to the two brake circuits by piston advance and piston return. At the same time, a pressure equalization between the two brake circuits can take place via a circuit separating valve connecting the two brake circuits in its open position.

The double-stroke piston can advantageously have two differently sized effective areas in the piston forward stroke and piston return stroke. As a rule, the effective piston area in the piston return stroke is only 50% of the effective piston area in the piston advance stroke, with the advantage that the piston force and thus motor torque, e.g. via a spindle drive, in the piston return stroke is only 50% of the piston force in the piston advance stroke, with the same pressure on the effective area. This is advantageously used to achieve twice the maximum pressure, e.g. up to 200 bar, with the same maximum motor torque during the piston return stroke. In the case of the piston advance stroke, on the other hand, only up to 100 bar can be achieved. This fulfills the main requirement that pressure buildup and release is possible over the entire pressure range from 0-200 bar with precise pressure control by piston advance and piston return stroke at any position of the piston.

With the valve circuit according to the invention, the double-stroke piston can advantageously be used for about twenty different operations, if these are to be carried out without compromising dynamics and positioning accuracy. In contrast to the complex valve circuits known from DE 10 20110830312 or DE 10 2018221783, the valve circuit of the hydraulic actuation system according to the invention is significantly simpler, less expensive and smaller.

Even in the event of failure of one hydraulic circuit, the other circuit in the actuation system according to the invention is still ready for use. By providing a redundant motor winding, a higher reliability of the actuator is also achieved. The valve circuit according to the invention can also be used flexibly, so it can also be used for a wide variety of requirements of the hydraulic unit for ABS, ESP and other assistance functions.

To increase safety, a safety shut-off valve, in particular one that is de-energized, can also be arranged in the connecting line that connects the pressure supply to the reservoir and in which a 3/2-way valve is arranged, which disconnects the hydraulic connection between the reservoir and the 3/2-way valve, in particular in the event of malfunction and/or leakage of the 3/2-way valve. This means that even if the 3/2-way valve is leaking, the pressure in at least one wheel brake can still be built up or changed by closing the additional safety shut-off valve by means of the pressure supply.

In the following, the hydraulic actuation system according to the invention and its mode of operation are explained in more detail with the aid of drawings.

They show:

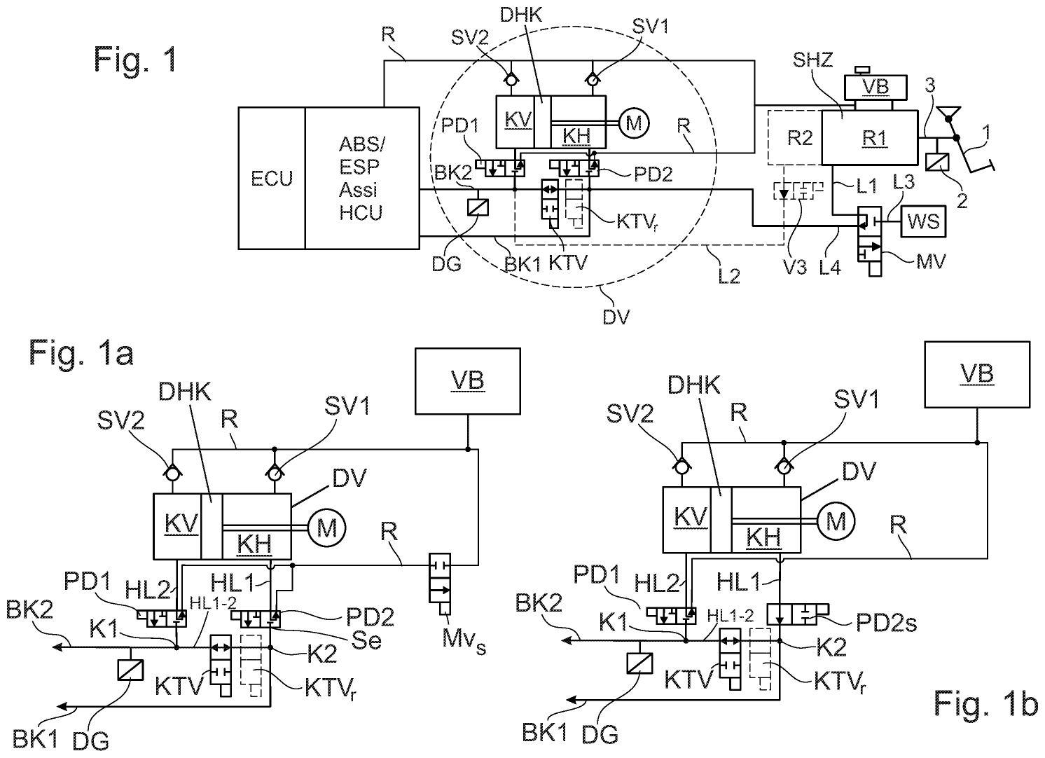

FIG. 1: A possible embodiment of the hydraulic actuation system for supplying pressure to a brake system;

FIG. 1a: Sectional enlargement of the pressure generation device with two 3/2-way valves;

FIG. 1b: Enlarged section of the pressure-generating device with only one 3/2-way valve;

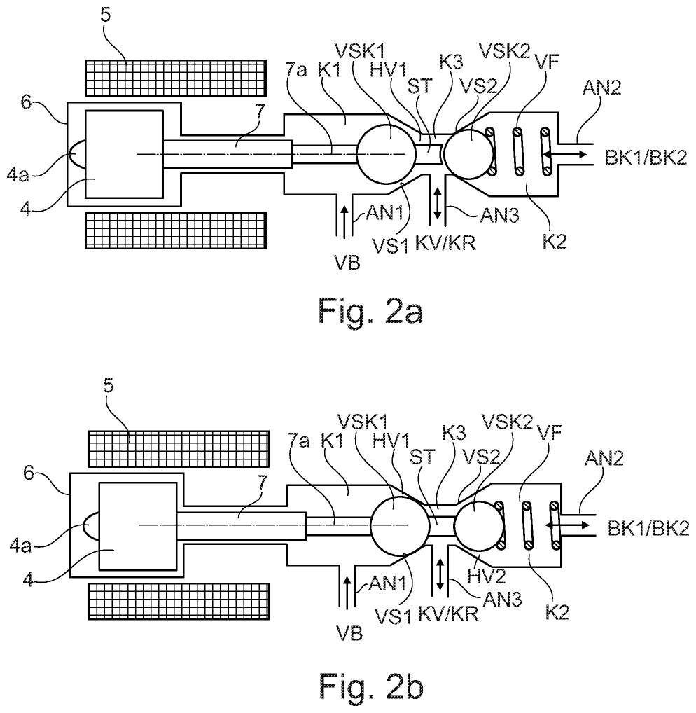

FIGS. 2a and 2b: Schematic illustrations of the 3/2-way valve according to the invention in the de-energized (FIG. 2a) and energized (FIG. 2b) state;

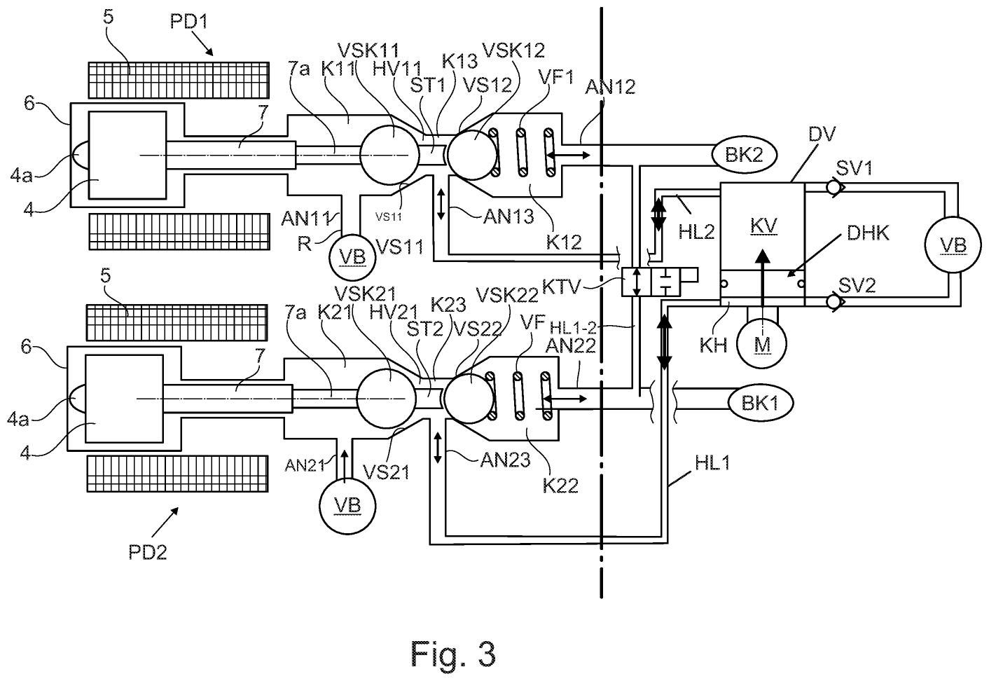

FIG. 3: schematic representation of the actuation system according to FIG. 1a;

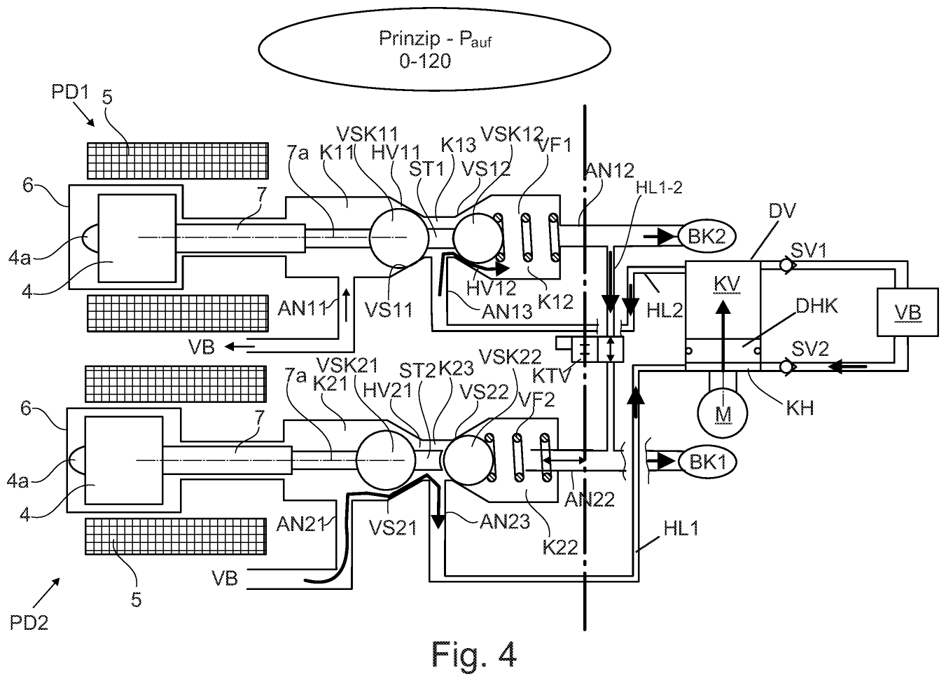

FIG. 4: schematic representation of the actuation system according to FIG. 1a during pressure build-up in the piston pre-stroke;

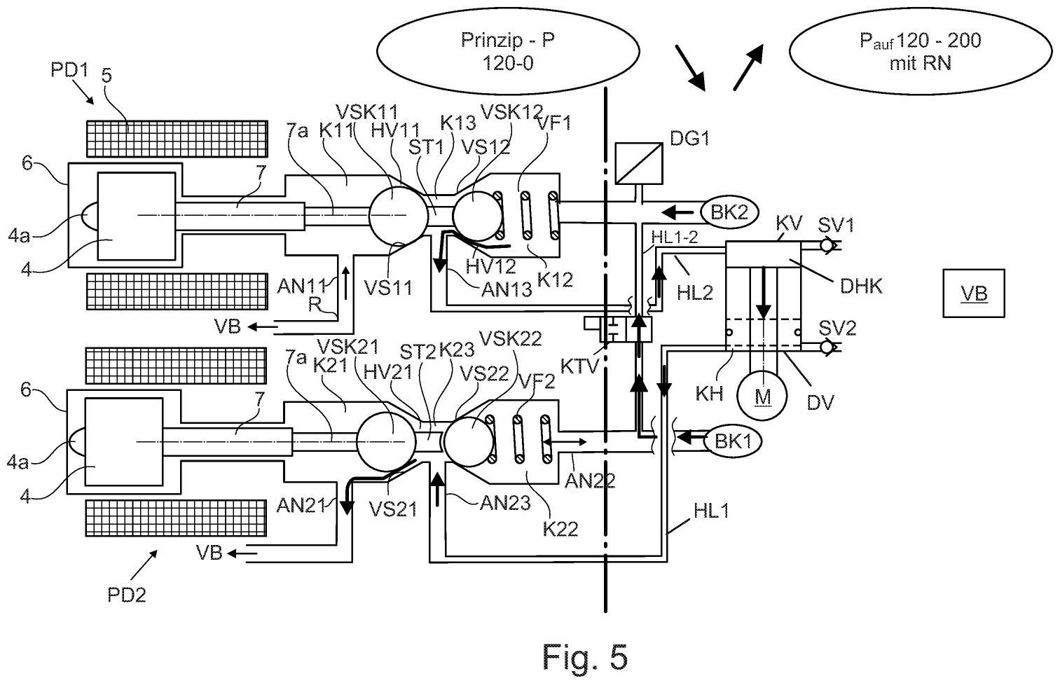

FIG. 5: schematic representation of the actuation system according to FIG. 1a during pressure reduction in the piston return stroke;

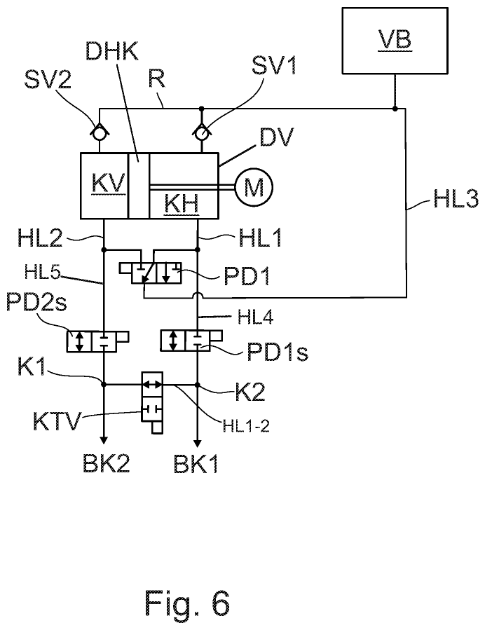

FIG. 6: Second possible embodiment of the hydraulic actuation system according to the invention with only one 3/2-way valve, whereby one working chamber of the pressure generating device is always in hydraulic connection with the reservoir;

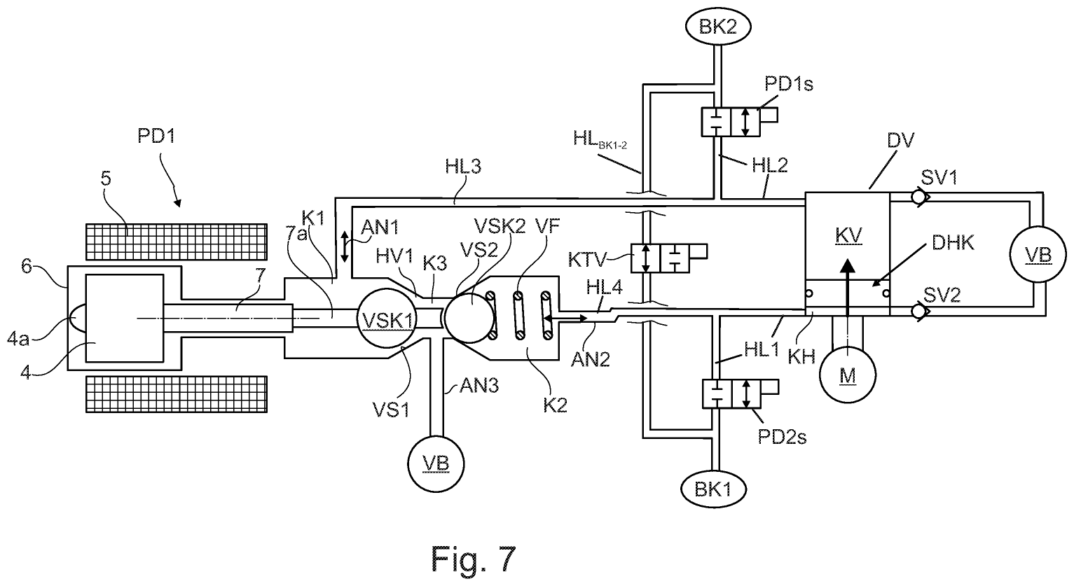

FIG. 7: Schematic representation of the actuation system according to FIG. 6;

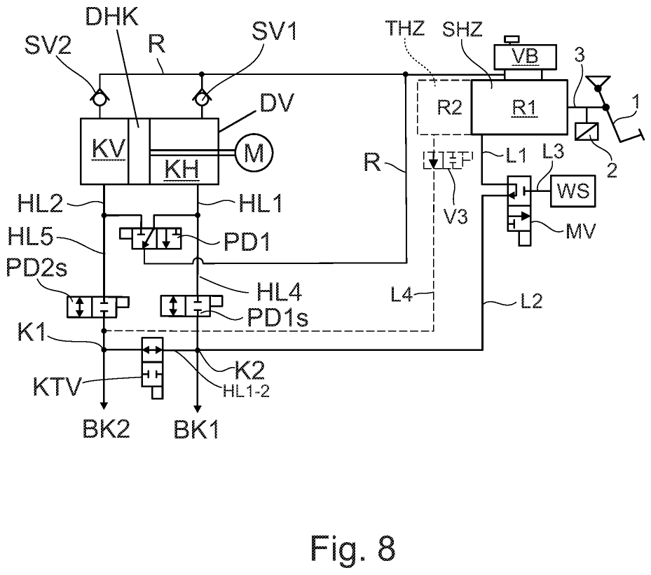

FIG. 8: Use of the actuation system according to FIG. 6 in a brake system with a master brake cylinder;

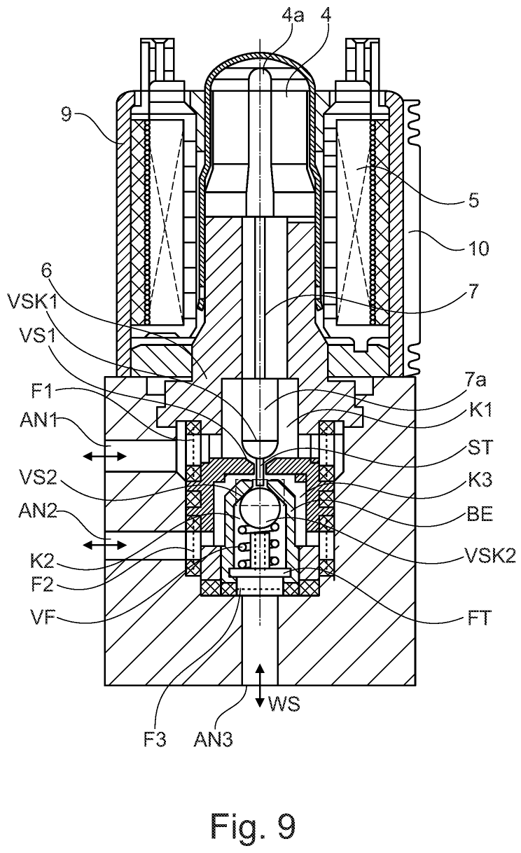

FIG. 9: Cross-section through a possible embodiment of the 3/2-W control valve according to the invention.

FIG. 1 shows a system with master brake cylinder HZ, e.g. single master brake cylinder SHZ with one working chamber R1 or tandem master brake cylinder THZ with two working chambers R1 and R2, together with a reservoir VB and pedal travel sensor 2. In the case of the single master brake cylinder SHZ, a hydraulic line L1 leads via a 3/2-way valve MV to the pressure supply DV and to the brake circuit BK1. Via the 3/2-way valve MV, the working chamber R1 is optionally connected via hydraulic line L3 to the travel simulator WS or, in the unpowered normal position, to the brake circuit BK1. The hydraulic line L4 leads directly to the 3/2-way valve PD2 and via the circuit isolating valve KTV to the brake circuit BK2. The working chamber KV of the pressure generating device DV is connected via the 3/2 directional control valve PD1 either to the second brake circuit BK2 or to the supply reservoir via the return line R. The 3/2-way valves PD1 and PD2 are the main components of the double-stroke piston DHK which are described in detail in FIGS. 3-5. The two circuits of the pressure supply DV lead to the hydraulic unit HCU for ABS, ESP and assistance functions, which are supplied with pressure by the pressure supply DV. The pressure generation device can be used not only to build up pressure but also to reduce it.

FIG. 1a shows the actuation system according to FIG. 1 alone, with a 3/2-way valve assigned to each working chamber KV, KH. In the return line R to the reservoir VB a normally closed 2/2 shut-off valve MVs is arranged, which is normally open and which becomes effective in case of a failure of the leaky valve seat Se of one of the valves PD1 and PD2. In this case the valve MVs is closed. This is the case when leakage flow occurs in the valve PD1 or PD2 in the non-energized state and flows into the return line R. This can be detected, for example, via the additional volume consumption of brake circuit BK2 or BK1 by means of the pV characteristic or via an unintentional pressure change in brake circuit BK2 or BK1. The MVs valve can, but does not have to be provided.

FIG. 1b shows an alternative embodiment in which the second 3/2-way valve PD2 is replaced by a 2/2-way valve so that the working chamber KH can no longer be connected to the reservoir VB.

FIG. 2a shows a schematic representation of a possible embodiment of a 3/2 directional control valve MV for the braking system according to the invention. The 3/2 directional control valve MV has an exciter winding 5 arranged around a magnet yoke 6, in which the magnet armature 4 is adjustable in axial direction to the pin 7, 7a. A stop element 4a is arranged at the left end of the magnet armature 4, which abuts against the inner wall of the magnet yoke 6 in the non-energized second switching state of the valve MV shown in FIG. 2a. At the right end of the connecting bolt 7, 7a, the first valve closing body VSK1 is arranged, which is firmly connected to the connecting bolt end 7a. The first valve closing body VSK1 acts together with the first valve seat VS1, which can be part of the solenoid yoke 6. The solenoid yoke 6 forms a first valve chamber K1 in the area of the bolt section 7a, which is in communication with the first valve port an AN1 for connection of the brake circuit BK1 via a hydraulic channel.

The 3/2-way valve MV also has a second valve chamber K2 in which the valve spring VF and a second valve closing body VSK2 are arranged. The second valve chamber K2 is connected via a hydraulic channel to the second valve port AN2, to which the path simulator WS is connected. The second valve chamber K2 forms with its left side the second valve seat VS2 of the valve MV, which cooperates with the second valve closing body VSK2. A third valve chamber K3 is arranged between the two valve seats VS1 and VS2 and is connected to the third valve connection AN3 for the master cylinder SHZ or THZ. On the side of the first valve closing body VSK1 facing away from the pin 7, 7a, a plunger ST is formed or fastened, the length of which is dimensioned such that it passes through the first valve seat VS1 and the third valve chamber K3 and can act with its free end on the second valve closing body VSK2 in the energized state of the 3/2-way valve MV. In Figure the pressure supply device is connected to the second brake circuit BK2.

FIG. 2b shows the “energized” state of the solenoid valve MV, in which the armature is shifted to the right by the magnetic field of the excitation coil, whereby the first valve closing body VSK1 presses to the right and with the plunger ST against the second valve closing body VSK2 and pushes this away from the second valve seat VS2 against the spring force of the valve spring VF, whereby the pressure supply device DV is now connected to the reservoir VB. The hydraulic connection HV1 between the first valve chamber K1 and the third valve chamber K3 is thereby opened, whereby the working chamber of the pressure generating device DV is connected to the reservoir VB and the brake circuit is disconnected.

The dimensioning of the valve spring VF determines the opening pressure in the return plane, e.g. in the event of failure of the first brake circuit or the pressure supply device DZ. Here, the legislator requires that a vehicle deceleration of 0.24 g can be generated with a foot force on brake pedal 1 of 500N. By dimensioning the valve spring to 75 bar opening pressure in the master cylinder, almost 3 times the deceleration value can be achieved.

The valve spring VF should be dimensioned in such a way that the solenoid armature 4 is reset more safely and the valve closing body VSK is pressed against the first valve seat VS1 in a secure sealing manner.

FIG. 3 shows the connections of the two 3/2-way valves PD1 and PD2 to the double-lift piston DHK. In the de-energized rest position shown, the valve closing bodies VSK11 and VSK21 of both 3/2-way valves PD1 and PD2 are pressed against the respective valve seats VS11 and VS21, thus closing the hydraulic connection between ports AN11 and AN13 or AN21 and AN23. When pressure is applied to the brake circuits BK1 and BK2, the hydraulic medium acting on the valve closing bodies VSK11 and VSK21 exerts an additional force in the closing direction.

The chamber KV acting in the piston advance stroke is connected via the hydraulic line HL2 to the central third valve port AN13 of the first 3/2-way valve PD1, whereas the chamber KH acting in the piston return stroke is connected via the hydraulic line HL1 to the central third valve port AN23 of the second 3/2-way valve PD2.

The respective second valve ports AN12 and AN22 are connected to the brake circuits BK2 and BK1. The brake circuits BK1 and BK2 are connected to each other and separated from each other in the energized state by a de-energized circuit isolating valve KTV. To build up and reduce pressure, the DHK double-stroke piston moves with a forward or return stroke. The pressure acting in the line/valve supports the valve opening at the two valve seats.

The KTV circuit isolating valve is closed in the event of failure of a BK1 or BK2 brake circuit. To safeguard against a double fault: In the event of failure of a brake circuit BK1 or BK2 and simultaneous failure of the circuit isolating valve KTV, this circuit isolating valve KTV can also be designed redundantly, e.g. by means of a further circuit isolating valve KTVr connected in series.

FIG. 4 shows the arrangement for the pressure buildup function with the double-stroke piston DHK on piston advance. Here, the piston moves upward in the diagram, the volume flow is directed via the energized 3/2-way valve PD1 with open valve seat VS22 and closed valve seat VS12 into the brake circuit BK2 and via the circuit isolating valve KTV into the brake circuit BK1. During the piston pre-stroke movement, the double-stroke piston draws volume from the reservoir VB via the open valve seat VS21 of the valve PD2 and via the suction valve SV2.

FIG. 5 shows the pressure reduction during the return stroke of the double-stroke piston DHK with the valve seat VS12 open. Here again, the pressure compensation between the two brake circuits BK1 and BK2 acts via the circuit separating valve KTV. The back pressure acts on the valve seats VS12 and VS22 due to the pressure reduction speed. This can be measured and regulated or controlled by the pressure transmitter via the motor torque or via current or pressure.

From this piston position before the double-stroke piston return stroke, the pressure build-up can also be set in the high pressure range up to e.g. 200 bar. Here, the 3/2-way valve PD2 is energized, causing valve seat VS21 to close and valve seat VS22 to open. This increases the pressure in brake circuit BK1 and, via the circuit isolating valve KTV, also in brake circuit BK2. During the piston return stroke movement, the double-stroke piston draws volume from the reservoir VB via the open valve seat VS1 and via the suction valve SV1 and VS11 of PD1.

FIG. 6 shows another possible embodiment of the actuation system according to the invention, whereby here only a 3/2-way valve PD1 is provided, with which either the first working chamber KV or the second working chamber KH is connected to the reservoir VB via the hydraulic line HL3. The controlled switching valve PD1s is used for selective hydraulic connection of the first hydraulic line HL1 or the second working chamber KH to a first hydraulic circuit BK1. A second controlled switching valve PD2s in turn serves for selective hydraulic connection of the second hydraulic line HL2 or the first working chamber KV to a second hydraulic circuit BK2, wherein in particular the second hydraulic line HL2 is connected to the second hydraulic circuit BK2 via a fifth hydraulic line HL5, wherein the second controlled switching valve PD2s serves for selective shut-off or opening of the fifth hydraulic line HL5. A third controlled circuit isolating valve KTV can be used to hydraulically connect or isolate both hydraulic circuits BK1, BK2.

FIG. 7 shows the schematic diagram of the circuit shown in FIG. 6.

FIG. 8 shows the actuation system according to FIGS. 6 and 7 in use in a brake system with a master brake cylinder, which can be designed as a single master brake cylinder SHZ with only one working chamber R1 or as a tandem master brake cylinder THZ with two working chambers R1 and R2. The connection of the master brake cylinder corresponds essentially to that described in FIG. 1.

FIG. 9 shows a possible design of the 3/2-way valve. The upper part, consisting of solenoid armature 4, excitation coil 5, solenoid yoke 6, corresponds to the structure of a standard 2/2-way inlet valve for an antilock braking system (ABS). For this reason, no detailed description is given here and only the lower part, which converts the 2/2-way valve into a 3/2-way valve, is described in detail.

The solenoid yoke 6 serves as a guide for the bolt 7, 7a, which is connected to the first valve closing body VSK1. Compared to the standard design of the 2/2-way inlet valve, the pin 7 can be made smaller in diameter, which increases the effective void area. This also allows the installation of a permanent magnet PM in the yoke 6 for force assistance of the return spring VF, as described in FIG. 6, in order to achieve smaller power losses. The first valve closing body VSK1 acts together with the first valve seat VS1 and is hemispherical in shape to achieve or ensure a secure sealing effect. The first valve seat VS1 is arranged in the solenoid yoke 6. However, the first valve seat VS1 can also be integrated in the magnet yoke 6 or implemented via a flanged plate. A plunger ST is formed on the first valve closing body VSK1 or else connected to the bolt 7a. The plunger engages through the first valve seat VS1 and acts on the second valve closing body VSK2, which is formed as a ball and cooperates with the second valve seat VS2.

As shown, the second valve seat VS2 can be combined with the ball VSK2 and the valve spring VF in a separate housing as a unit. This offers advantages in pre-assembly and valve adjustment. For this purpose, the assembly unit is pressed into the yoke housing. To measure the tappet stroke, the ball stop has a hole to record the path of the ball via a measuring pin. For a secure connection of the assembly unit to the solenoid yoke, a power supply is recommended. To protect the valve seats VS1 and VS2, all connections to the brake circuit, master cylinder and travel simulator are protected by F1, F2 and F3 filters.

The valve adjustment is made in such a way that the tappet ST has a small distance to the ball VSK2.

To reduce coil heating, the excitation winding 5 can be potted with the solenoid housing 9. In addition, a ribbed heat sink 10 may also be provided.

### LIST OF REFERENCE SIGNS

1 Pedal
2 reservoir
3 Piston plunger
4 Magnet armature
4a Stop of solenoid armature 4
5 Exciter winding
6 Solenoid yoke
7, 7a Pin
7, 7a Bolt
AN1, AN2, AN3 Valve connections
BK1, BK2 first and second brake circuit
BP1, BP2 Separating valves
DV Pressure supply device
F1, F2, F3 Filter
FP Force due to hydraulic pressure
H stroke of solenoid armature
HV1 first hydraulic connection
HV2 second hydraulic connection
K1, K2, K3 valve chamber
HLi Hydraulic lines
MV, PD1, PD2 3/2-way valves
PD1s, PD2s Separating valve
R1, R2 Working chambers of master cylinder
SHZ/THZ Single or tandem master brake cylinder
VF Valve spring
VS1, VS11 first valve seat
VS2, VS22 second valve seat
VSK11, VSK22 valve closing body
WS Travel simulator
MVs Shut-off valve

1. A hydraulic actuation system for a hydraulic a braking system, comprising:
at least one hydraulic circuit having at least one hydraulic consumer, in the form of a hydraulically actuated wheel brake, and
at least a first pressure generating device comprising a piston pump, which is used for pressure control or regulation in the at least one hydraulic circuit wherein
the pressure-generating device an is arranged to be selectively connected to or disconnected from a reservoir by means of at least a first controlled 3/2-way valve.

2. The hydraulic actuating system according to claim 1, wherein the piston pump includes a plunger piston or double-stroke piston and at least a first working chamber, and wherein the first controlled 3/2-way valve is assigned to the first working chamber, thereby enabling connection of the first working chamber to a first hydraulic circuit of the at least one hydraulic circuit or to the reservoir by means of the first controlled 3/2-way valve.

3. The hydraulic actuating system according to claim 2, wherein the first pressure generating device has a double-stroke piston that separates the first working chamber and a second working chamber of the first pressure generating device from one another in a sealing manner, and wherein a second controlled 3/2-way valve is assigned to the second working chamber, it being possible by means of the second controlled 3/2-way valve to connect either the second working chamber to a second hydraulic circuit or to the reservoir.

4. The hydraulic actuating system according to claim 2, further comprising a controlled switching valve assigned to the second working chamber, wherein the controlled switching valve is a 2/2-way valve via which the second working chamber is enabled to be connected to or disconnected from a second hydraulic circuit of the at least one hydraulic circuit.

5. The hydraulic actuating system according claim 4, further comprising a circuit separating valve disposed to enable selective hydraulic connection or separation of the first and second hydraulic circuits by opening or shutting off a hydraulic line connecting the first and second hydraulic circuits.

6. The hydraulic actuating system according to claim 5, further comprising a circuit isolating valve arranged in series with the circuit separating valve in the hydraulic line connecting the first and second hydraulic circuits.

7. The hydraulic actuating system according to claim 1, wherein the pressure generating device has includes a double-stroke piston that separates first and second working chambers from one another in a sealing manner, and wherein at least one of the two working chambers is always connected to a reservoir by means of the first controlled 3/2-way valve.

8. The hydraulic actuating system according to claim 7, wherein in an intermediate position of the first controlled 3/2-way valve, the first and second working chambers of the pressure generating device are simultaneously connected to the reservoir.

9. The hydraulic actuating system according to claim 7, wherein a first hydraulic line connects the first working chamber to a first valve connection of the first controlled 3/2-way valve and a second hydraulic line connects the second working chamber to a second valve connection of the first controlled 3/2-way valve, and wherein a third valve connection of the first controlled 3/2-way valve is connected to the reservoir via a third hydraulic line.

10. The hydraulic actuating system according to claim 9, wherein, in a first valve position of the first controlled 3/2-way valve, only the first valve connection of the first controlled 3/2-way valve is in hydraulic connection with the third valve connection of the first controlled 3/2-way valve, and wherein, in a second valve position of the first controlled 3/2-way valve, only the second valve connection of the first controlled 3/2-way valve is in hydraulic connection with the third valve connection of the first controlled 3/2-way valve.

11. The hydraulic actuating system according to claim 10, wherein, in positions between the first and the second valve positions all of the first, second, and third valve connections of the first controlled 3/2-way valve are hydraulically connected to each other.

12. The hydraulic actuating system according to claim 9, further comprising a controlled switching valve arranged to selectively hydraulically connect the first hydraulic line, which is connected to the second working chamber, to a first hydraulic circuit of the at least one hydraulic circuit via a fourth hydraulic line, wherein the controlled switching valve selectively shuts off or opens the fourth hydraulic line.

13. The hydraulic actuating system according to claim 9, further comprising a controlled switching valve arranged to selectively hydraulically connect the second hydraulic line, which is connected to the first working chamber, to a second hydraulic circuit of the at least one hydraulic circuit via a fifth hydraulic line, wherein the controlled switching valve selectively shuts off or opens the fifth hydraulic line.

14. The hydraulic actuating system according to claim 12, wherein the second working chamber is selectively hydraulically connected to a second hydraulic circuit of the at least one hydraulic circuit, the system further comprising a further controlled switching valve arrange to selectively hydraulically connect the first and second hydraulic circuits.

15. The hydraulic actuating system according to claim 1, wherein the pressure generating device is enabled to draw hydraulic medium into at least one working chamber from the reservoir via at least one suction valve.

16. The hydraulic actuating system according to claim 1, wherein the piston pump comprises a double-stroke piston, and wherein a pressure or a piston position is able to be adjusted or set by means of the double-stroke piston both in the forward stroke and in the return stroke.

17. The hydraulic actuating system according to claim 1, further comprising a safety shut-off valve that is open when de-energised, arranged in a connecting line that connects a directional control valve to the reservoir and disconnects the hydraulic connection between the reservoir and the directional control valve in an event of malfunction and/or leakage of the directional control valve.

18. A brake system including the hydraulic actuation system according to claim 1, wherein each of the at least one hydraulic circuit is coupled to at least one hydraulically acting wheel brake.
